(19) United States
(12) Patent Application Publication
(10) Pub. No.: US 2026/0296901 A1
(43) Pub. Date: Oct. 1, 2026

(54) METHOD FOR PRODUCING CATION-MODIFIED SILICA AND CATION-MODIFIED SILICA DISPERSION LIQUID

(71) Applicant: FUJIMI INCORPORATED, Aichi (JP)

(72) Inventor: Yasunori OKADA, Aichi (JP)

(21) Appl. No.: 19/565,727

(22) Filed: Mar. 13, 2026

(30) Foreign Application Priority Data
Mar. 28, 2025 (JP) 2025-055177

(51) Int. Cl. C01B 33/12

(52) U.S. Cl. CPC C01B 33/128; C01P 2004/64; C01P 2006/90

(57) ABSTRACT

The present invention provides a means for suppressing a change in zeta potential in cation-modified silica under acidic conditions. The present disclosure relates to a method for producing cation-modified silica, including a mixing step of adding a liquid B containing a silane coupling agent having a cationic group dropwise to a liquid A containing silica particles to prepare a mixed liquid C, wherein, in the mixing step, control is performed so that the mixed liquid C is maintained at a temperature of higher than 35° C. and 70° C. or lower.

### CROSS-REFERENCE TO RELATED APPLICATION

The present application is based on Japanese Patent Application No. 2025-055177 filed on Mar. 28, 2025, and the contents disclosed therein are incorporated herein by reference in their entirety.

### TECHNICAL FIELD

The present invention relates to a method for producing cation-modified silica and a cation-modified silica dispersion liquid.

### BACKGROUND ART

In a semiconductor device manufacturing process, as performance of semiconductor devices improves, techniques for manufacturing wiring with higher density and higher integration are required. In such a semiconductor device manufacturing process, CMP (chemical mechanical polishing) has become an essential process. As semiconductor circuits are increasingly miniaturized, high flatness is required for irregularities of patterned wafers, and it is also required to achieve high smoothness on a nano-order by CMP. In order to achieve high smoothness by CMP, it is preferable to polish convex portions of a patterned wafer at a high polishing removal rate while polishing concave portions as little as possible.

Here, during CMP, in addition to a polishing agent referred to as abrasive grains, it is common to use a composition containing various additives such as a polishing accelerator and a pH adjusting agent (a polishing composition). Here, the abrasive grains (polishing agent) are particles having a function of adhering to a surface of an object to be polished and scraping off the surface by physical action. As a raw material for the abrasive grains (polishing agent) when producing the polishing composition, a silica dispersion liquid such as colloidal silica, in which silica (silicon oxide; SiO₂) particles capable of serving as abrasive grains (polishing agent) are used as a dispersoid, is normally used.

This silica dispersion liquid is known to have poor stability because silica particles aggregate with each other under acidic conditions. Therefore, in order to suppress aggregation between silica particles, for example, according to Japanese Patent Laid-Open No. 2005-162533 and International Patent Publication No. WO 2017/170660 (corresponding to U.S. Patent Application Publication No. 2019/0127230), methods in which colloidal silica is modified with a silane coupling agent having a cationic group have been proposed.

### SUMMARY OF INVENTION

### Technical Problem

The present inventors have conducted studies on the techniques described in the above patent documents and found that, although stability under acidic conditions can be improved, there remain issues to be improved in these techniques. That is, it has been found that, in cation-modified silica dispersion liquids produced using these techniques, the zeta potential changes over time. When the zeta potential of the cation-modified silica dispersion liquid changes, it may be difficult to obtain desired performance when the cation-modified silica dispersion liquid is used as a raw material.

Therefore, an object of the present invention is to provide a means for suppressing a change in zeta potential in cation-modified silica under acidic conditions.

### Solution to Problem

The present inventors have conducted diligent studies in order to solve the problem described above. As a result, the present inventors have found that the above problem can be solved by the means described below, and have completed the present invention.

That is, the above-described problem of the present invention can be solved by a method for producing cation-modified silica, including a mixing step of adding a liquid B containing a silane coupling agent having a cationic group dropwise to a liquid A containing silica particles to prepare a mixed liquid C, wherein, in the mixing step, control is performed so that the mixed liquid C is maintained at a temperature of higher than 35° C. and 70° C. or lower.

In addition, the above-described problem of the present invention can be solved by a cation-modified silica dispersion liquid, wherein a rate of reduction in zeta potential after 14 days in a dispersion liquid having a pH of 4 or less is less than 19%.

### DESCRIPTION OF EMBODIMENTS

Hereinafter, embodiments of the present invention will be described. The embodiments shown here are examples to embody the technical concept of the present invention and are not intended to limit the present invention. Hence, all other practicable embodiments, methods of use, and techniques of operation, etc., which may be contemplated by those skilled in the art, etc., to the extent not departing from the gist of the present invention, are included in the scope and gist of the present invention, as well as in the scope of the present invention described in the claims and its equivalents. The embodiments described in the present specification can be optionally combined to make other embodiments.

In the present specification, the expression “X to Y” is used in the sense that it includes the numerical values listed before and after “to” (X and Y) as the lower limit value and the upper limit value, and means “X or more and Y or less”. Also, in the present specification, unless otherwise specified, operations and measurements of physical properties, etc., are carried out under conditions of room temperature (in the range of 20° C. or higher and 25° C. or lower)/relative humidity of 40% RH or more and 50% RH or less. Also, when characteristics or aspects of the present disclosure are described from the viewpoint of a Markush group, those skilled in the art will recognize that the present disclosure is thereby described from the viewpoint of any individual constituent element of the Markush group or a subgroup of constituent elements. In addition, all combinations of the embodiments and descriptions disclosed in the present specification must be understood to be disclosed in the present application. That is, they must be understood as potentially serving as a basis for amendment.

The first aspect of the present invention is a method for producing cation-modified silica, including a mixing step of adding a liquid B containing a silane coupling agent having a cationic group dropwise to a liquid A containing silica particles to prepare a mixed liquid C, wherein, in the mixing step, control is performed so that the mixed liquid C is maintained at a temperature of higher than 35° C. and 70° C. or lower. According to the method for producing cation-modified silica according to the present aspect, a change in zeta potential of the cation-modified silica under acidic conditions can be suppressed. That is, the cation-modified silica obtained by the method for producing cation-modified silica according to the present aspect exhibits a small change in zeta potential under acidic conditions. Hence, the second aspect of the present invention is cation-modified silica obtained by the method for producing cation-modified silica according to the present aspect, and specifically, is a cation-modified silica dispersion liquid, wherein a rate of reduction in zeta potential after 14 days in a dispersion liquid having a pH of 4 or less is less than 19%. Note that the “zeta (ζ) potential” refers to a potential difference generated at an interface between a solid and a liquid in contact with each other when they are in relative motion, and as the absolute value of the zeta potential increases, repulsion between particles becomes stronger and stability of the particles becomes higher, whereas as the absolute value of the zeta potential approaches zero, the particles tend to aggregate more easily.

The reason why the method for producing cation-modified silica according to the present aspect achieves the above effect is not necessarily clear, but is presumed as follows. Note that the present invention is not limited by the following presumption. By performing mixing of the liquid A and the liquid B at higher than 35° C. and 70° C. or lower, it is considered that the silane coupling agent is bonded to the surface of the silica particles while securing appropriate space, and cationization of each silica particle proceeds in a well-balanced manner.

Hereinafter, embodiments of the present invention will be described in detail.

### <<Liquid A>>

In the method for producing cation-modified silica according to the present aspect, the liquid A contains silica particles. Preferably, the liquid A contains silica particles and a dispersing medium. In the present specification, the liquid A may also be referred to as “silica particle-containing dispersion liquid”.

### [Silica Particles]

The silica particles are a raw material before cation modification (alteration) using a predetermined silane coupling agent described below, and contain silica. In the present specification, the silica particles may also be referred to as “silica raw material”. Preferably, the silica particles are colloidal silica (hereinafter, colloidal silica as the silica raw material may also be referred to as “raw material colloidal silica”, and detailed description will be given taking as an example a case where the silica raw material is raw material colloidal silica).

The raw material colloidal silica may be produced by a sol-gel method, for example. Raw material colloidal silica produced by the sol-gel method is preferable because the contents of metal impurities diffusive in semiconductors and corrosive ions such as chloride ion are small. Production of raw material colloidal silica by the sol-gel method can be carried out using a conventionally known method, and specifically, raw material colloidal silica can be obtained by using a hydrolyzable silicon compound (for example, an alkoxysilane or a derivative thereof) as a raw material and subjecting it to a hydrolysis and condensation reaction. As this silicon compound, a single type may be used alone, or two or more types may be used in combination. Alternatively, the raw material colloidal silica may be produced by a method other than the sol-gel method, or a commercially available product may also be used.

In one embodiment, the above-described silicon compound is preferably an alkoxysilane represented by the following general formula (1) or a derivative thereof.

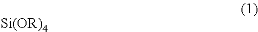

In the general formula (1), R is an alkyl group, preferably a lower alkyl group having 1 to 8 carbon atoms, and more preferably a lower alkyl group having 1 to 4 carbon atoms. Here, examples of R include a methyl group, an ethyl group, a propyl group, an isopropyl group, a butyl group, a pentyl group, and a hexyl group, and tetramethoxysilane in which R is a methyl group, tetraethoxysilane in which R is an ethyl group, and tetraisopropoxysilane in which R is an isopropyl group are preferable. In addition, examples of derivatives of the alkoxysilane include low-condensation products obtained by partial hydrolysis of the alkoxysilane. In the production method according to the present aspect, it is preferable to use tetramethoxysilane in view of ease of controlling the hydrolysis rate, ease of obtaining fine silica particles (for example, silica particles of 10 nm or more and 100 nm or less), and a small amount of unreacted residue.

The above-described silicon compound undergoes hydrolysis and condensation in a reaction solvent to form colloidal silica. As the reaction solvent, water or an organic solvent containing water may be used. Examples of the organic solvent include hydrophilic organic solvents such as alcohols including methanol, ethanol, isopropanol, n-butanol, t-butanol, pentanol, ethylene glycol, propylene glycol, and 1,4-butanediol, and ketones including acetone and methyl ethyl ketone. Among these organic solvents, it is particularly preferable to use alcohols such as methanol, ethanol, and isopropanol, and from the viewpoint of post-treatment of the reaction solvent, etc., it is more preferable to use an alcohol having the same alkyl group as the alkyl group (R) of the raw material silicon compound (for example, methanol for tetramethoxysilane). One of these organic solvents may be used alone, or two or more thereof may be used in combination. The amount of the organic solvent used is not particularly limited, but it is preferably about 5 to 50 moles per mole of the silicon compound. If 5 moles or more are used, sufficient miscibility with the silicon compound can be ensured, and if 50 moles or less are used, a reduction in production efficiency is suppressed. The amount of water added to the organic solvent is not particularly limited, and it is sufficient if an amount necessary for hydrolysis of the silicon compound is present. The amount of water is preferably about 2 to 15 moles per mole of the silicon compound. Note that the amount of water mixed with the organic solvent has a significant influence on the particle size of the colloidal silica to be formed. Increasing the amount of water added allows the particle size of the colloidal silica to be increased. Also, decreasing the amount of water added allows the particle size of the colloidal silica to be decreased. Hence, by changing the mixing ratio between water and the organic solvent, the particle size of the colloidal silica to be produced can be arbitrarily adjusted.

With respect to the reaction solvent for the hydrolysis and condensation reaction of the silicon compound for obtaining colloidal silica, it is preferable to add a basic catalyst to adjust the reaction solvent to be alkaline (Stober process). As a result, the reaction solvent is preferably adjusted to a pH of 8 to 11, and more preferably to a pH of 8.5 to 10.5, enabling rapid formation of colloidal silica. As the basic catalyst, from the viewpoint of preventing contamination with impurities, organic amines or ammonia are preferable, and in particular, preferred examples thereof include ethylenediamine, diethylenetriamine, triethylenetetramine, ammonia, urea, ethanolamine, and tetramethylammonium hydroxide.

To hydrolyze and condense the silicon compound in the reaction solvent, the silicon compound as a raw material may be added to an organic solvent and stirred under temperature conditions of 0 to 100° C., preferably 0 to 50° C. By hydrolyzing and condensing the silicon compound while stirring it in an organic solvent containing water, colloidal silica having a uniform particle size can be obtained.

In the liquid A, the silica particles are normally present in the form of secondary particles, which are aggregates of primary particles. The average particle size of the secondary particles of the silica particles (average secondary particle size) is preferably 10 nm or more, more preferably 15 nm or more, still more preferably 20 nm or more, particularly preferably 30 nm or more, and most preferably 30 nm or more. In the liquid A, the average particle size of the secondary particles of the silica particles (average secondary particle size) is preferably 500 nm or less, more preferably 200 nm or less, still more preferably 150 nm or less, particularly preferably 100 nm or more, and most preferably 80 nm or less. That is, the average particle size of the secondary particles of the silica particles (average secondary particle size) in the liquid A is preferably 10 nm or more and 500 nm or less, more preferably 15 nm or more and 200 nm or less, still more preferably 20 nm or more and 150 nm or less, particularly preferably 30 nm or more and 100 nm or less, and most preferably 30 nm or more and 80 nm or less. According to one embodiment, the average secondary particle size of the silica particles in the liquid A is 10 nm or more and 100 nm or less. When the average particle size of the secondary particles of the silica particles (average secondary particle size) is within the above range, the effect of suppressing a change in zeta potential in the cation-modified silica dispersion liquid is further demonstrated. Note that, as the value of the average secondary particle size, a value measured as a volume average particle size by a dynamic light scattering method using a particle size distribution measuring device (UPA-UT151, manufactured by Nikkiso Co., Ltd.), as described in the Examples section below, is employed.

Also, in the liquid A, the average primary particle size of the silica particles is preferably 5 nm or more, more preferably 10 nm or more, still more preferably 12 nm or more, particularly preferably 15 nm or more, and most preferably 20 nm or more. In the liquid A, the average primary particle size of the silica particles is preferably 200 nm or less, more preferably 150 nm or less, still more preferably 120 nm or less, particularly preferably 80 nm or less, and most preferably 50 nm or less. That is, the average primary particle size of the silica particles in the liquid A is preferably 5 nm or more and 200 nm or less, more preferably 10 nm or more and 150 nm or less, still more preferably 12 nm or more and 120 nm or less, particularly preferably 15 nm or more and 80 nm or less, and most preferably 20 nm or more and 50 nm or less. When the average primary particle size of the silica particles is within the above range, the effect of suppressing a change in zeta potential in the cation-modified silica dispersion liquid is further demonstrated. Note that, as described in the Examples section below, the diameter of the silica particles (primary particles) (primary particle size of the silica particles) can be calculated based on the specific surface area (SA) of the silica particles calculated by a BET method, assuming that the shape of the silica particles is a true sphere, using a formula of SA=4πR². Note that the value of the degree of association (average secondary particle size/average primary particle size) calculated from these values is not particularly restricted either, and is preferably about 1.0 to 5.0.

In the method for producing cation-modified silica according to the present aspect, the silica particles contained in the liquid A preferably have a silanol group density of more than 0 groups/nm² and 5 groups/nm² or less, more preferably 0.5 groups/nm² or more and 5 groups/nm² or less, still more preferably 0.6 groups/nm² or more and 4.9 groups/nm² or less, particularly preferably 0.8 groups/nm² or more and 4.8 groups/nm² or less, and most preferably 0.9 groups/nm² or more and 4.7 groups/nm² or less. According to one embodiment, the silanol group density of the silica particles in the liquid A is 1 group/nm² or more and 4.0555 groups/nm² or less. When the silanol group density of the silica particles is within the above range, the effect of suppressing a change in zeta potential in the cation-modified silica dispersion liquid is further demonstrated. In the present specification, the “silanol group density” means the number of silanol groups per unit area on the surface of the silica particles. The silanol group density is an index for representing the electrical characteristics or chemical characteristics of the surface of the silica particles.

In the present specification, the silanol group density is calculated and determined based on a specific surface area measured by a BET method and an amount of silanol groups measured by titration. Details of the measurement of the silanol group density will be described in detail in the Examples below.

It is preferable to use, as the silica particles contained in the liquid A, those exhibiting a negative value for zeta potential. The zeta potential of the silica particles, as a value immediately before reaction with a silane coupling agent described below, is preferably −60 mV or more, more preferably −55 mV or more, still more preferably −50 mV or more, particularly preferably −45 mV or more, and most preferably −40 mV or more. Note that there is no particular restriction on the upper limit value of this zeta potential value, and it is normally about −10 mV or less, preferably −20 mV or less, more preferably −25 mV or less, still more preferably −30 mV or less. As the zeta potential value in the present specification, a value measured by a method described in the Examples section below is employed.

Note that, in the method for producing cation-modified silica according to the present aspect, the pH of the silica particles to be subjected to the reaction (that is, the pH of the liquid A) is, from the viewpoint of reaction with a silane coupling agent, preferably 5.0 or more and 11.0 or less, more preferably 6.0 or more and 10.5 or less, still more preferably 7.0 or more and 10.0 or less, and particularly preferably 7.5 or more and 9.0 or less.

In addition, as necessary, various processing steps may be further applied to the silica particles provided as described above. Examples of such processing steps include a step of adding an alkaline solution (an aqueous solution of various bases such as aqueous ammonia) or an organic solvent to the silica particles; and a step of replacing part or all of the reaction solvent serving as a dispersing medium of the silica particles with water. By adding an alkaline solution (an aqueous solution of various bases such as aqueous ammonia) or an organic solvent, the viscosity of the silica particle-containing dispersion liquid can be reduced. There is no particular restriction on the amount of the alkaline solution or organic solvent added at this time, and it may be set as appropriate in consideration of the viscosity of the silica particle-containing dispersion liquid obtained after the addition. The method for replacing the dispersing medium (reaction solvent) of the silica particles with water is not particularly limited, and examples thereof include a method in which colloidal silica obtained by the production method as described above is concentrated, and then water is added dropwise in a fixed amount while heating. By replacing the dispersing medium of the silica particles with water, the effect of suppressing a change in zeta potential in the cation-modified silica dispersion liquid is further demonstrated.

Here, the silica concentration (content) in the liquid A (silica particle-containing dispersion liquid) is preferably 5% by mass or more, more preferably 10% by mass or more, still more preferably 12% by mass or more, particularly preferably 15% by mass or more, and most preferably 18% by mass or more, with respect to the entire mass of the liquid A. In addition, the silica concentration in the liquid A (silica particle-containing dispersion liquid) is preferably 40% by mass or less, more preferably 35% by mass or less, still more preferably 30% by mass or less, particularly preferably 25% by mass or less, and most preferably 22% by mass or less, or 20% by mass or less, with respect to the entire mass of the liquid A. That is, the silica concentration in the liquid A (silica particle-containing dispersion liquid) is preferably 5% by mass or more and 40% by mass or less, more preferably 10% by mass or more and 35% by mass or less, still more preferably 12% by mass or more and 30% by mass or less, particularly preferably 15% by mass or more and 25% by mass or less, and most preferably 18% by mass or more and 22% by mass or less, or 18% by mass or more and 20% by mass or less, with respect to the entire mass of the liquid A. When the silica concentration in the liquid A (silica particle-containing dispersion liquid) is within the above range, the effect of suppressing a change in zeta potential in the cation-modified silica dispersion liquid is further demonstrated.

### [Dispersing Medium]

The liquid A contains a dispersing medium in which the silica particles are dispersed. Examples of the dispersing medium include the reaction solvent used in the above-described method for producing colloidal silica. From the viewpoint of dispersion stability of cation-modified silica, the dispersing medium is preferably water.

Hence, when an organic solvent other than water is used as the reaction solvent in the above-described method for producing colloidal silica, as described above, it is preferable to replace the dispersing medium (reaction solvent) of the silica particles with water.

In addition, when the silica particles are obtained in the form of powder, the silica particles may be dispersed in water.

Here, the concentration (content) of the dispersing medium in the liquid A (silica particle-containing dispersion liquid) is preferably 95% by mass or less, more preferably 90% by mass or less, still more preferably 88% by mass or less, particularly preferably 85% by mass or less, and most preferably 82% by mass or less, with respect to the entire mass of the liquid A. In addition, the concentration of the dispersing medium in the liquid A (silica particle-containing dispersion liquid) is preferably 60% by mass or more, more preferably 65% by mass or more, still more preferably 70% by mass or more, particularly preferably 75% by mass or more, and most preferably 78% by mass or more, with respect to the entire mass of the liquid A. When the concentration of the dispersing medium in the liquid A (silica particle-containing dispersion liquid) is within the above range, the effect of suppressing a change in zeta potential in the cation-modified silica dispersion liquid is further demonstrated.

As described above, it is preferable that the content of an organic solvent in the dispersing medium is as small as possible, and from this viewpoint, when the entire amount of the dispersing medium is taken as 100% by mass, the proportion of water content is preferably 90% by mass or more, more preferably 95% by mass or more, still more preferably 98% by mass or more, and particularly preferably 100% by mass. Note that, when the dispersing medium contains an organic solvent, examples of such an organic solvent include the above-described organic solvents such as methanol, ethanol, and isopropanol.

### <<Liquid B>>

In the method for producing cation-modified silica according to the present aspect, the liquid B contains a silane coupling agent having a cationic group.

### [Silane Coupling Agent Having Cationic Group]

In the method for producing cation-modified silica according to the present aspect, a silane coupling agent having a cationic group is added to the silica particles (silica particle-containing dispersion liquid) provided as described above. This allows a reaction to proceed between the silica particles (hydroxyl groups present on the surface thereof) and hydrolyzable silyl groups of the silane coupling agent. As a result, one end of the silane coupling agent is bonded to or adsorbed onto the surface of the silica particles, and the other end (a cationic group) becomes exposed in large numbers on the surface of the silica particles. As a result, in the cation-modified silica, an improvement in zeta potential is confirmed as compared with the silica particles. Here, the term “cationic group” means a group that is positively charged in a solvent (dispersing medium) such as water. There is no particular restriction on the specific form of the cationic group, and examples thereof include an amino group (a primary amino group, a secondary amino group, and a tertiary amino group), an acid-neutralized salt of an amino group, a quaternary ammonium group, a primary amide group, a secondary amide group, and a tertiary amide group.

In addition, the silane coupling agent having a cationic group used at this time may be any one having a cationic group as described above, and examples thereof include N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, 3-aminopropyltriethoxysilane (APTES) (also known as γ-aminopropyltriethoxysilane), 3-aminopropyltrimethoxysilane (also known as γ-aminopropyltrimethoxysilane), γ-triethoxysilyl-N-(α,γ-dimethyl-butylidene) propylamine, N-phenyl-γ-aminopropyltrimethoxysilane, a hydrochloride of N-(vinylbenzyl)-β-aminoethyl-γ-aminopropyltriethoxysilane, and octadecyldimethyl-(γ-trimethoxysilylpropyl)-ammonium chloride. Among these, N-(β-aminoethyl)-γ-aminopropyltrimethoxysilane, N-(β-aminoethyl)-γ-aminopropyltriethoxysilane, 3-aminopropyltriethoxysilane, and 3-aminopropyltrimethoxysilane are preferably used because they have favorable reactivity with the silica raw material. Note that, in the present invention, one of these silane coupling agents may be used alone, or two or more thereof may be used in combination.

### [Solvent]

The liquid B may contain a solvent in which the silane coupling agent having a cationic group is dissolved (dispersed).

In the method for producing cation-modified silica according to the present aspect, the liquid B is added dropwise to the liquid A. At this time, as the liquid B, it is preferable to add the silane coupling agent having a cationic group as it is without dilution, or to add it in the form of a solution (aqueous dispersion liquid). As the liquid B, it is more preferable to add the silane coupling agent having a cationic group in the form of a solution (aqueous dispersion liquid). Hence, according to one embodiment, the liquid B contains the silane coupling agent having a cationic group and a solvent.

As the solvent used in the liquid B, the reaction solvent used in the above-described method for producing colloidal silica can be mentioned, but from the viewpoint of the effect of suppressing a change in zeta potential in the cation-modified silica dispersion liquid, it is preferable that the solvent is water. Hence, according to one embodiment, the liquid B contains the silane coupling agent having a cationic group and water. That is, according to one embodiment, the silane coupling agent having a cationic group is used dissolved (dispersed) in water.

Here, the addition of the silane coupling agent having a cationic group “without dilution” is regarded as addition of the silane coupling agent having a cationic group at a concentration of “100% by mass”. When the silane coupling agent having a cationic group is added in the form of a solution (aqueous dispersion liquid), that is, the concentration (content) of the silane coupling agent having a cationic group in the liquid B is preferably 0.001% by mass or more, more preferably 0.005% by mass or more, still more preferably 0.01% by mass or more, particularly preferably 0.03% by mass or more, and most preferably 0.05% by mass or more, with respect to the entire mass of the liquid B. In addition, the concentration of the silane coupling agent having a cationic group in the liquid B is preferably 5% by mass or less, more preferably 2% by mass or less, still more preferably 1% by mass or less, particularly preferably 0.5% by mass or less, and most preferably 0.3% by mass or less, with respect to the entire mass of the liquid B. That is, the concentration of the silane coupling agent having a cationic group in the liquid B is preferably 0.001% by mass or more and 5% by mass or less, more preferably 0.005% by mass or more and 2% by mass or less, still more preferably 0.01% by mass or more and 1% by mass or less, particularly preferably 0.03% by mass or more and 0.5% by mass or less, and most preferably 0.05% by mass or more and 0.3% by mass or less, with respect to the entire mass of the liquid B. According to one embodiment, in the liquid B, the silane coupling agent having a cationic group is contained in an amount of 0.001% by mass or more and 0.5% by mass or less, with respect to the entire mass of the liquid B. When the concentration of the silane coupling agent having a cationic group in the liquid B is within the above range, the effect of suppressing a change in zeta potential in the cation-modified silica dispersion liquid is further demonstrated.

In the method for producing cation-modified silica according to the present aspect, the pH of the liquid B is, from the viewpoint of reaction with the silica particles, preferably 5.0 or more and 11.0 or less, more preferably 6.0 or more and 10.5 or less, still more preferably 7.0 or more and 10.0 or less, and particularly preferably 7.5 or more and 9.0 or less.

### <<Mixed Liquid C>>

The mixed liquid C is obtained by carrying out a mixing step of adding the liquid B containing the silane coupling agent having a cationic group dropwise to the liquid A containing the silica particles. Here, in the mixing step, by performing control so that the mixed liquid C is maintained at a temperature of higher than 35° C. and 70° C. or lower, a cation-modified silica dispersion liquid in which a change in zeta potential in the cation-modified silica dispersion liquid is suppressed can be obtained.

### [Mixing Step]

The temperature at which the mixed liquid C is maintained in the mixing step is preferably 38° C. or higher and 68° C. or lower, more preferably 40° C. or higher and 65° C. or lower, still more preferably 42° C. or higher and 63° C. or lower, particularly preferably 43° C. or higher and 62° C. or lower, and most preferably 45° C. or higher and 60° C. or lower. When the mixed liquid C is maintained within the above range in the mixing step, the effect of suppressing a change in zeta potential in the cation-modified silica dispersion liquid is further demonstrated.

In the mixing step, it is preferable that the mixed liquid C is stirred while being maintained at a temperature of higher than 35° C. and 70° C. or lower. In addition, in the mixing step, the time during which the mixed liquid C is maintained at a temperature of higher than 35° C. and 70° C. or lower is preferably 5 minutes or more and 360 minutes or less, more preferably 10 minutes or more and 270 minutes or less, still more preferably 15 minutes or more and 210 minutes or less, particularly preferably 20 minutes or more and 180 minutes or less, and most preferably 30 minutes or more and 120 minutes or less. When the time during which the mixed liquid C is maintained at a temperature of higher than 35° C. and 70° C. or lower is within the above range, the effect of suppressing a change in zeta potential in the cation-modified silica dispersion liquid is further demonstrated.

In the mixing step, it is preferable that the liquid A is at a temperature of higher than 35° C. and 70° C. or lower (added at a temperature of higher than 35° C. and 70° C. or lower). That is, prior to the mixing step, it is preferable that the liquid A is heated to a temperature of preferably higher than 35° C. and 70° C. or lower. The liquid A is preferably at 38° C. or higher and 68° C. or lower, more preferably at 40° C. or higher and 65° C. or lower, still more preferably at 42° C. or higher and 63° C. or lower, particularly preferably at 43° C. or higher and 62° C. or lower, and most preferably at 45° C. or higher and 60° C. or lower. When the liquid A is added within the above range in the mixing step, the effect of suppressing a change in zeta potential in the cation-modified silica dispersion liquid is further demonstrated.

In the mixing step, it is preferable that the liquid B is at a temperature of higher than 35° C. and 70° C. or lower (added at a temperature of higher than 35° C. and 70° C. or lower). That is, prior to the mixing step, it is preferable that the liquid B is heated to a temperature of preferably higher than 35° C. and 70° C. or lower. The liquid B is preferably at 38° C. or higher and 68° C. or lower, more preferably at 40° C. or higher and 65° C. or lower, still more preferably at 42° C. or higher and 63° C. or lower, particularly preferably at 43° C. or higher and 62° C. or lower, and most preferably at 45° C. or higher and 60° C. or lower. When the liquid B is added within the above range in the mixing step, the effect of suppressing a change in zeta potential in the cation-modified silica dispersion liquid is further demonstrated.

The dropwise addition rate of the liquid B in the mixing step is preferably 0.5 mL/min or more, more preferably 1 mL/min or more, still more preferably 2 mL/min or more, particularly preferably 5 mL/min or more, and most preferably 10 mL/min or more. In addition, the dropwise addition rate of the liquid B in the mixing step is preferably 50 mL/min or less, more preferably 35 mL/min or less, still more preferably 30 mL/min or less, particularly preferably 25 mL/min or less, and most preferably 20 mL/min or less. That is, the dropwise addition rate of the liquid B in the mixing step is preferably 0.5 mL/min or more and 50 mL/min or less, more preferably 1 mL/min or more and 35 mL/min or less, still more preferably 2 mL/min or more and 30 mL/min or less, particularly preferably 5 mL/min or more and 25 mL/min or less, and most preferably 10 mL/min or more and 20 mL/min or less. According to one embodiment, the dropwise addition rate of the liquid B in the mixing step is 1 mL/min or more and 40 mL/min or less, 1 mL/min or more and 30 mL/min or less, or 5 mL/min or more and 20 mL/min or less. When the dropwise addition rate of the liquid B in the mixing step is within the above range, the effect of suppressing a change in zeta potential in the cation-modified silica dispersion liquid is further demonstrated.

As the mass ratio between the silica particles and the silane coupling agent having a cationic group when obtaining the mixed liquid C, with respect to 100% by mass of the silica particles, the silane coupling agent having a cationic group is preferably 0.05% by mass or more, more preferably 0.1% by mass or more, still more preferably 0.5% by mass or more, particularly preferably 0.8% by mass or more, and most preferably 1% by mass or more. In addition, as the mass ratio between the silica particles and the silane coupling agent having a cationic group when obtaining the mixed liquid C, with respect to 100% by mass of the silica particles, the silane coupling agent having a cationic group is preferably 20% by mass or less, more preferably 15% by mass or less, still more preferably 12% by mass or less, particularly preferably 10% by mass or less, and most preferably 5% by mass or less. That is, as the mass ratio between the silica particles and the silane coupling agent having a cationic group when obtaining the mixed liquid C, with respect to 100% by mass of the silica particles, the silane coupling agent having a cationic group is preferably 0.05% by mass or more and 20% by mass or less, more preferably 0.1% by mass or more and 15% by mass or less, still more preferably 0.5% by mass or more and 12% by mass or less, particularly preferably 0.8% by mass or more and 10% by mass or less, and most preferably 1% by mass or more and 5% by mass or less. According to one embodiment, the silane coupling agent having a cationic group is 0.07% by mass or more, 0.08% by mass or more, 0.10% by mass or more, 0.12% by mass or more, or 0.15% by mass or more, with respect to 100% by mass of the silica particles. According to one embodiment, the silane coupling agent having a cationic group is 3% by mass or less, 2% by mass or less, 1% by mass or less, 0.8% by mass or less, or 0.5% by mass or less, with respect to 100% by mass of the silica particles. According to one embodiment, the silane coupling agent having a cationic group is 0.07% by mass or more and 3% by mass or less, 0.08% by mass or more and 2% by mass or less, 0.10% by mass or more and 1% by mass or less, 0.12% by mass or more and 0.8% by mass or less, or 0.15% by mass or more and 0.5% by mass or less, with respect to 100% by mass of the silica particles. When the mass ratio between the silica particles and the silane coupling agent having a cationic group is within the above range, the effect of suppressing a change in zeta potential in the cation-modified silica dispersion liquid is further demonstrated.

In the method for producing cation-modified silica according to the present aspect, the pH of the mixed liquid C (that is, the pH of the liquid in which the liquid A and the liquid B are mixed) is, from the viewpoint of reaction between the silane coupling agent and the silica particles, preferably 5.0 or more and 11.0 or less, more preferably 6.0 or more and 10.5 or less, still more preferably 7.0 or more and 10.0 or less, and particularly preferably 7.5 or more and 9.0 or less.

### [Cation-Modified Silica Dispersion Liquid]

According to the production method according to the present aspect, a cation-modified silica dispersion liquid containing cation-modified silica formed by modifying the surface of silica particles with a cationic group, and a dispersing medium for dispersing the cation-modified silica is obtained. That is, according to another aspect of the present invention, there is provided a cation-modified silica dispersion liquid containing cation-modified silica obtained by modifying the surface of silica particles with a cationic group, and a dispersing medium for dispersing the cation-modified silica. Here, the expression “cation-modified silica” means a state in which a cationic group has been introduced onto the surface of silica particles as a modifying group (for example, an amino group, an acid-neutralized salt of an amino group, a quaternary ammonium group, or the like).

The cation-modified silica dispersion liquid may contain, in addition to the cation-modified silica and the dispersing medium, other components such as a pH adjusting agent, a reaction raw material including silica particles or a silane coupling agent, and a raw material-derived component. For example, the cation-modified silica dispersion liquid may be one obtained by stirring the mixed liquid C obtained by mixing the liquid A and the liquid B while maintaining it at a temperature of higher than 35° C. and 70° C. or lower. According to one embodiment, the cation-modified silica dispersion liquid may be one obtained by adding a pH adjusting agent such as an acid or an alkali to a liquid obtained by stirring the mixed liquid C obtained by mixing the liquid A and the liquid B while maintaining it at a temperature of higher than 35° C. and 70° C. or lower. According to one embodiment, the method for producing cation-modified silica of the present aspect includes a step of adding a pH adjusting agent to a dispersion liquid obtained by stirring the mixed liquid C while maintaining it at a temperature of higher than 35° C. and 70° C. or lower.

As the pH adjusting agent, known acids, bases, or salts thereof can be used. Specific examples of the acids that can be used as the pH adjusting agent include: inorganic acids such as hydrochloric acid, sulfuric acid, nitric acid, hydrofluoric acid, boric acid, carbonic acid, hypophosphorous acid, phosphorous acid, and phosphoric acid; and organic acids such as formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, diglycolic acid, 2-furancarboxylic acid, 2,5-furandicarboxylic acid, 3-furancarboxylic acid, 2-tetrahydrofurancarboxylic acid, methoxyacetic acid, methoxyphenylacetic acid, and phenoxyacetic acid.

Specific examples of the bases that can be used as the pH adjusting agent include organic bases such as amines including aliphatic amines including ethanolamine and 2-amino-2-ethyl-1,3-propanediol and aromatic amines, and quaternary ammonium hydroxides, alkali metal hydroxides such as potassium hydroxide, Group 2 metal hydroxides, tetramethylammonium hydroxide, and ammonia.

The above pH adjusting agents can be used alone, or two or more thereof can be used in a mixture.

In addition, in combination with the above acid, an ammonium salt or an alkali metal salt such as a sodium salt or a potassium salt of the above acid may be used as a pH buffer.

There is no particular restriction on the amounts of the pH adjusting agent and the pH buffer added, and they may be adjusted as appropriate so that the pH of the cation-modified silica dispersion liquid falls within a desired range.

According to one embodiment, the cation-modified silica dispersion liquid contains cation-modified silica, a dispersing medium, and a pH adjusting agent. At this time, the pH of the cation-modified silica dispersion liquid is preferably 1.0 or more and 6.5 or less, more preferably 2.0 or more and 6.0 or less, still more preferably 2.0 or more and 5.0 or less, particularly preferably 2.0 or more and 4.0 or less, and most preferably 2.5 or more and 3.5 or less. That is, according to one embodiment, according to the method for producing cation-modified silica of the present aspect, a cation-modified silica dispersion liquid having a pH of 1.0 or more and 6.5 or less (preferably 2.0 or more and 5.0 or less) is obtained.

There is no particular restriction on the particle size of the cation-modified silica contained in the cation-modified silica dispersion liquid, and forms similar to those described above for the particle size of the silica raw material (average primary particle size, average secondary particle size, and degree of association) can be preferably employed.

As described above, in cation-modified silica, there has been a problem that the zeta potential changes over time under acidic conditions. However, in the cation-modified silica dispersion liquid obtained by the method for producing cation-modified silica according to the present aspect, a change in the zeta potential of the cation-modified silica under acidic conditions can be suppressed. That is, in the cation-modified silica dispersion liquid, a reduction over time in positive zeta potential possessed by the cation-modified silica can be suppressed. According to one embodiment, for the cation-modified silica dispersion liquid according to the present aspect, the rate of reduction in zeta potential after 14 days in a dispersion liquid having a pH of 4 or less is less than 19%, as measured in the Examples below. The above-described rate of reduction in zeta potential of the cation-modified silica in the cation-modified silica dispersion liquid is preferably 18% or less, more preferably 17% or less, still more preferably 16% or less, particularly preferably 15% or less, and most preferably 12% or less.

Here, the cation-modified silica in the cation-modified silica dispersion liquid is preferably 10 mV or more, more preferably 12 mV or more, still more preferably 15 mV or more, particularly preferably 16 mV or more, and most preferably 18 mV or more. That is, the cation-modified silica in the cation-modified silica dispersion liquid has a zeta potential at a pH of 3.0 of preferably 10 mV or more, more preferably 12 mV or more, still more preferably 15 mV or more, particularly preferably 16 mV or more, and most preferably 18 mV or more.

Furthermore, there is no particular restriction on the concentration of the cation-modified silica in the cation-modified silica dispersion liquid; however, it is preferably 5% by mass or more, more preferably 10 to 50% by mass, and still more preferably 10 to 40% by mass. According to one embodiment, the concentration of the cation-modified silica in the cation-modified silica dispersion liquid is 0.5% by mass or more, 1% by mass or more, 1.5% by mass or more, 5% by mass or more, 10% by mass or more, or 15% by mass or more. According to one embodiment, the concentration of the cation-modified silica in the cation-modified silica dispersion liquid is 40% by mass or less, 30% by mass or less, 25% by mass or less, 20% by mass or less, 10% by mass or less, or 5% by mass or less. Meanwhile, in the cation-modified silica dispersion liquid, the remainder excluding the content of the cation-modified silica is water or the like as the dispersing medium, and a trace amount of a catalyst or the like. In consideration of the above-described range of the cation-modified silica concentration, the concentration of the dispersing medium in the cation-modified silica dispersion liquid is preferably 90% by mass or less, more preferably 50 to 90% by mass, and still more preferably 60 to 90% by mass. In addition, it is also preferable that the content of an organic solvent in the dispersing medium is as small as possible from the viewpoint that removal is required depending on the intended use; from this viewpoint, when the entire amount of the dispersing medium is taken as 100% by mass, the proportion of water content is preferably 90% by mass or more, more preferably 95% by mass or more, still more preferably 98% by mass or more, and even more preferably 100% by mass. Note that, when the dispersing medium contains an organic solvent, examples of such an organic solvent include the above-described organic solvents such as methanol, ethanol, and isopropanol.

In the method for producing cation-modified silica according to the present aspect, the pH of the cation-modified silica dispersion liquid is, from the viewpoint of the above-described control of zeta potential, preferably 1.0 or more and 6.5 or less, more preferably 2.0 or more and 6.0 or less, still more preferably 2.0 or more and 5.0 or less, particularly preferably 2.0 or more and 4.0 or less, and most preferably 2.5 or more and 3.5 or less.

The cation-modified silica dispersion liquid according to the present aspect can be used for various applications such as a polishing agent (abrasive grains) contained in a polishing composition and a paper coating agent, and can have a stable zeta potential over a wide pH range (particularly even under acidic conditions) for a long period of time. Hence, it also exhibits an excellent effect in that it has long-term dispersion stability.

The embodiments of the present invention are described in detail above, but are given for explanatory and illustrative purposes only, and are not limited. The scope of the present invention should be obviously construed on the basis of the attached claims.

The present invention encompasses the following aspects and embodiments:
[1] a method for producing cation-modified silica, comprising a mixing step of adding a liquid B containing a silane coupling agent having a cationic group dropwise to a liquid A containing silica particles to prepare a mixed liquid C, wherein, in the mixing step, control is performed so that the mixed liquid C is maintained at a temperature of higher than 35° C. and 70° C. or lower;
[2] the method for producing cation-modified silica according to the above [1], wherein, in the mixing step, the liquid B is added dropwise at a dropwise addition rate of 1 mL/min or more and 40 mL/min or less;
[3] the method for producing cation-modified silica according to the above [1] or [2], wherein a silanol group density of the silica particles in the liquid A is 0.9 groups/nm² or more and 4.7 groups/nm² or less;
[4] the method for producing cation-modified silica according to any one of the above [1] to [3], wherein an average secondary particle size of the silica particles in the liquid A is 10 nm or more and 100 nm or less;
[5] the method for producing cation-modified silica according to any one of the above [1] to [4], wherein, in the liquid B, the silane coupling agent having a cationic group is contained in an amount of 0.001% by mass or more and 0.5% by mass or less with respect to an entire mass of the liquid B;
[6] the method for producing cation-modified silica according to any one of the above [1] to [5], wherein, before the mixing step, the liquid A is heated to a temperature of higher than 35° C. and 70° C. or lower;
[7] the method for producing cation-modified silica according to any one of the above [1] to [6], wherein, before the mixing step, the liquid B is heated to a temperature of higher than 35° C. and 70° C. or lower;
[8] the method for producing cation-modified silica according to any one of the above [1] to [7], wherein a mass ratio between the silica particles and the silane coupling agent having a cationic group when obtaining the mixed liquid C is such that the silane coupling agent having a cationic group is 0.05% by mass or more and 20% by mass or less with respect to 100% by mass of the silica particles;
[9] the method for producing cation-modified silica according to any one of the above [1] to [8], wherein, in the mixing step, control is performed so that the mixed liquid C is maintained at a temperature of 40° C. or higher and 65° C. or lower; and
[10] a cation-modified silica dispersion liquid, wherein a rate of reduction in zeta potential after 14 days in a dispersion liquid having a pH of 4 or less is less than 19%.

### EXAMPLES

The present invention will be described in further detail using the following Examples and Comparative Examples. However, the technical scope of the present invention is not restricted to the following Examples alone. Note that, unless otherwise specified, “%” and “part(s)” refer to “% by mass” and “parts by mass”, respectively. Also, in the following Examples, unless otherwise specified, operations were carried out under conditions of room temperature (25° C.)/relative humidity of 40% RH or more and 50% RH or less.

### [Methods for Measuring Various Physical Properties]

In the present Examples, various physical properties were measured by the following methods.

### <<Measurement of Particle Size>>

As the value of the average secondary particle size of silica particles contained in a silica dispersion liquid, a value measured as a volume average particle size by a dynamic light scattering method using a particle size distribution measuring device (UPA-UT151, manufactured by Nikkiso Co., Ltd.) was employed. In addition, the value of the average primary particle size of silica particles contained in a silica dispersion liquid was calculated based on the specific surface area (SA) of the silica particles calculated by a BET method, assuming that the shape of the silica particles is a true sphere, using a formula of SA=4πR².

### <<Measurement of Zeta Potential>>

Measurement of the zeta potentials of the silica particles and the obtained cation-modified silica dispersion liquid was carried out using a zeta potential measuring device manufactured by Malvern Panalytical Ltd. (trade name “Zetasizer nano”). Note that the zeta potential of the silica particles was measured without particularly adjusting the pH. On the other hand, the zeta potential of the cation-modified silica dispersion liquid was measured in accordance with the method described in <<Change over time in zeta potential>> described below.

### <<Method for Calculating Silanol Group Density>>

The silanol group density of abrasive grains (the number of silanol groups per unit surface area of abrasive grains, unit: groups/nm²) was calculated by measuring or calculating each parameter by the following measurement method or calculation method, and then calculating according to the expression (c) below.

More specifically, C in the expression (c) below is the total weight of the abrasive grains, and S in the expression (c) below is the BET specific surface area of the abrasive grains. Still more specifically, first, 1.50 g of the abrasive grains as solid content was collected in a 200 ml beaker, to which 100 ml of pure water was added to form a slurry, after which 30 g of sodium chloride was added and dissolved. Next, 1N hydrochloric acid was added to adjust the pH of the slurry to about 3.0 to 3.5, and then pure water was added until the slurry reached 150 ml. Using an automatic titrator (COM-80, manufactured by Hiranuma Sangyo Co., Ltd.), the slurry was adjusted to a pH of 4.0 at 25° C. using a 0.1 mol/L aqueous sodium hydroxide solution, and furthermore, the volume of a 0.1 mol/L aqueous sodium hydroxide solution, a [unit: ml], required to raise the pH from 4.0 to 9.0 was measured by pH titration. The silanol group density p can be calculated according to the following expression (c).

$$ρ = ( a \times 60.2 ) / ( C \times S ) \qquad expression ( c )$$

$$In the above expression ( c ) ,$$

$$ρ : silanol group density [ unit : groups / {nm}^{2} ]$$

$$a : volume of 0.1 mol / L sodium hydroxide solution [ unit : mL ]$$

$$C : weight of abrasive grains [ unit : g ]$$

$$S : BET specific surface area of silica particles [ unit : nm / g ] .$$

Note that, for the BET specific surface area of the abrasive grains, a measured value with a surface area measuring device manufactured by Micromeritics Instrument Corporation (Flow Sorb II 2300) was used.

### Production of Cation-Modified Silica

### Comparative Example 1

In a 2 L plastic jug, deionized water and synthetic amorphous silica (colloidal silica, average primary particle size: 24 nm, average secondary particle size: 47 nm, zeta potential: −47 mV (pH 7.5), silanol group density: 3.7 groups/nm²) were mixed to obtain 1000 g of a colloidal silica aqueous dispersion liquid (liquid A) in which the final concentration of the synthetic amorphous silica was 19.88% by mass. Note that the silica in the liquid A has an average primary particle size of 24 nm, an average secondary particle size of 47 nm, a zeta potential of −47 mV, and a silanol group density of 3.7 groups/nm².

Separately, 0.378 g of 3-aminopropyltriethoxysilane (APTES) and 420 g of deionized water were mixed to prepare an APTES aqueous solution (liquid B) having a concentration of 0.09% by mass.

While stirring 1000 g of the colloidal silica aqueous dispersion liquid (liquid A) at 230 rpm, the entire amount of the APTES aqueous solution (liquid B) prepared as described above was added dropwise at a dropwise addition rate of 12 mL/min. Thereafter, the obtained mixed liquid C was maintained at a stirring state at room temperature (25° C.) for 50 minutes, thereby obtaining a dispersion liquid of cation-modified (amino-modified) silica in which amino groups were introduced onto the surface of the silica. The average secondary particle size of the obtained cation-modified (amino-modified) silica was the same as that of the silica raw material.

### Example 1

A colloidal silica aqueous dispersion liquid (liquid A) was prepared by the same method as described above. In addition, an APTES aqueous solution (liquid B) was prepared by the same method as described above, except that APTES and deionized water were mixed while being heated to 60° C. Next, while heating the colloidal silica aqueous dispersion liquid (liquid A) to 60° C. and stirring at 230 rpm, the entire amount of the APTES aqueous solution (liquid B) was added dropwise at a dropwise addition rate of 12 mL/min. Thereafter, the obtained mixed liquid C was maintained at a stirring state for 50 minutes while being maintained at 60° C., thereby obtaining a dispersion liquid of cation-modified (amino-modified) silica in which amino groups were introduced onto the surface of the silica. The average secondary particle size of the obtained cation-modified (amino-modified) silica was the same as that of the silica raw material.

### Example 2

A colloidal silica aqueous dispersion liquid (liquid A) was prepared by the same method as described above. In addition, an APTES aqueous solution (liquid B) was prepared by the same method as described above, except that APTES and deionized water were mixed while being heated to 60° C. Next, while heating the colloidal silica aqueous dispersion liquid (liquid A) to 45° C. and stirring at 230 rpm, the entire amount of the APTES aqueous solution (liquid B) was added dropwise at a dropwise addition rate of 12 mL/min. Thereafter, the obtained mixed liquid C was maintained at a stirring state for 50 minutes while being maintained at 45° C., thereby obtaining a dispersion liquid of cation-modified (amino-modified) silica in which amino groups were introduced onto the surface of the silica. The average secondary particle size of the obtained cation-modified (amino-modified) silica was the same as that of the silica raw material.

### Comparative Example 2

A colloidal silica aqueous dispersion liquid (liquid A) was prepared by the same method as described above. In addition, an APTES aqueous solution (liquid B) was prepared by the same method as described above, except that APTES and deionized water were mixed while being cooled to 5° C. Next, while cooling the colloidal silica aqueous dispersion liquid (liquid A) to 5° C. and stirring at 230 rpm, the entire amount of the APTES aqueous solution (liquid B) was added dropwise at a dropwise addition rate of 12 mL/min. Thereafter, the obtained mixed liquid C was maintained at a stirring state for 50 minutes while being maintained at 5° C., thereby obtaining a dispersion liquid of cation-modified (amino-modified) silica in which amino groups were introduced onto the surface of the silica. The average secondary particle size of the obtained cation-modified (amino-modified) silica was the same as that of the silica raw material.

### [Evaluation]

For each of the obtained cation-modified (amino-modified) silica dispersion liquids, a change over time in zeta potential was measured, and the results are shown in Table 1. In addition, the preparation conditions for the cation-modified (amino-modified) silica dispersion liquids of Examples and Comparative Examples are also shown in Table 1.

### <<Change Over Time in Zeta Potential>>

Measurement of the zeta potential of the obtained cation-modified silica was performed using as a sample an aqueous dispersion liquid in which the cation-modified silica was dispersed in deionized water to a concentration of 1.8% by mass and the pH was then adjusted to 3.0 using sulfuric acid. The initial zeta potential was measured immediately after preparing each cation-modified (amino-modified) silica dispersion liquid (within 60 minutes after preparation), and the zeta potential after 14 days was measured using 100 mL of each cation-modified (amino-modified) silica dispersion liquid placed in a sealed polyethylene container and left to stand for 14 days in an air bath maintained at 25° C.

TABLE 1

| | Temperature of | Temperature of | | | | Rate of |
|---|---|---|---|---|---|---|
| | liquid B | liquid A | Temperature of | Initial zeta | Zeta potential | reduction in |
| | when mixing | when preparing | mixed liquid C | potential | after 14 days | zeta potential |
| | APTES and water | mixed liquid C | (maintained) | (mV) | (mV) | (%) |
| Example 1 | 60° C. | 60° C. | 60° C. | 23.08 | 20.52 | 11 |
| Example 2 | 60° C. | 45° C. | 45° C. | 22.98 | 19.33 | 15 |
| Comparative | 25° C. | 25° C. | 25° C. | 22.78 | 18.35 | 19 |
| Example 1 | | | | | | |
| Comparative | 5° C. | 5° C. | 5° C. | 23.47 | 16.28 | 31 |
| Example 2 | | | | | | |

As shown in Table 1, Examples 1 and 2, in which the temperature of the mixed liquid C obtained by adding the APTES aqueous solution (liquid B) dropwise to the colloidal silica aqueous dispersion liquid (liquid A) was maintained at higher than 35° C. and 70° C. or lower, are found to have a suppressed reduction in zeta potential and a rate of reduction in zeta potential of less than 19%. On the other hand, Comparative Examples 1 and 2, in which the temperature of the mixed liquid C was maintained at 35° C. or lower, are found to exhibit a large reduction in zeta potential.

As described above, according to the production method according to the present invention, by maintaining the temperature of the mixed liquid C at higher than 35° C. and 70° C. or lower, the resulting cation-modified silica is found to exhibit a suppressed reduction (change) in zeta potential even under acidic conditions to have high stability in zeta potential over time. Therefore, a dispersion liquid of cation-modified silica excellent in stability over time can be obtained.

The present application is based on Japanese Patent Application No. 2025-055177 filed on Mar. 28, 2025, and the contents disclosed therein are incorporated herein by reference in their entirety.

1. A method for producing cation-modified silica, comprising
a mixing step of adding a liquid B containing a silane coupling agent having a cationic group dropwise to a liquid A containing silica particles to prepare a mixed liquid C,
wherein, in the mixing step, control is performed so that the mixed liquid C is maintained at a temperature of higher than 35° C. and 70° C. or lower.

2. The method for producing cation-modified silica according to claim 1, wherein, in the mixing step, the liquid B is added dropwise at a dropwise addition rate of 1 mL/min or more and 40 mL/min or less.

3. The method for producing cation-modified silica according to claim 1, wherein a silanol group density of the silica particles in the liquid A is 0.9 groups/nm² or more and 4.7 groups/nm² or less.

4. The method for producing cation-modified silica according to claim 1, wherein an average secondary particle size of the silica particles in the liquid A is 10 nm or more and 100 nm or less.

5. The method for producing cation-modified silica according to claim 1, wherein, in the liquid B, the silane coupling agent having a cationic group is contained in an amount of 0.001% by mass or more and 0.5% by mass or less with respect to an entire mass of the liquid B.

6. The method for producing cation-modified silica according to claim 1, wherein, before the mixing step, the liquid A is heated to a temperature of higher than 35° C. and 70° C. or lower.

7. The method for producing cation-modified silica according to claim 1, wherein, before the mixing step, the liquid B is heated to a temperature of higher than 35° C. and 70° C. or lower.

8. The method for producing cation-modified silica according to claim 1, wherein, in the mixing step, control is performed so that the mixed liquid Cis maintained at a temperature of 40° C. or higher and 65° C. or lower.

9. The method for producing cation-modified silica according to claim 1, wherein a mass ratio between the silica particles and the silane coupling agent having a cationic group when obtaining the mixed liquid C is such that the silane coupling agent having a cationic group is 0.05% by mass or more and 20% by mass or less with respect to 100% by mass of the silica particles.

10. A cation-modified silica dispersion liquid, wherein a rate of reduction in zeta potential after 14 days in a dispersion liquid having a pH of 4 or less is less than 19%.
